(19) United States
(12) Patent Application Publication
(10) Pub. No.: US 2025/0320127 A1
(43) Pub. Date: Oct. 16, 2025

(54) NEGATIVE ELECTRODE ACTIVE MATERIALS FOR RECHARGEABLE LITHIUM BATTERIES, NEGATIVE ELECTRODES, AND RECHARGEABLE LITHIUM BATTERIES

(71) Applicant: SAMSUNG SDI CO., LTD., Yongin-si (KR)

(72) Inventors: Banseok LEE, Yongin-si (KR); Youngugk KIM, Yongin-si (KR); Deok-Hyun KIM, Yongin-si (KR); Sunil PARK, Yongin-si (KR); Eunji KANG, Yongin-si (KR); Ilyoung CHOI, Yongin-si (KR); Jaewon KIM, Yongin-si (KR); Hyejin KIM, Yongin-si (KR); Doori OH, Yongin-si (KR); Narae KIM, Yongin-si (KR); Yookyung KIM, Yongin-si (KR)

(21) Appl. No.: 19/177,520

(22) Filed: Apr. 12, 2025

(30) Foreign Application Priority Data
Apr. 12, 2024 (KR) 10-2024-0049629

(51) Int. Cl. C01B 39/02; H01M 10/0525

(52) U.S. Cl. CPC C01B 39/026; H01M 10/0525; C01P 2002/02; C01P 2002/72; C01P 2004/51; C01P 2004/61; C01P 2004/62; C01P 2004/64; C01P 2004/84; C01P 2006/14; C01P 2006/40

(57) ABSTRACT

A negative electrode active material includes a porous substrate including a zeolite and amorphous silicon filled in pores of the porous substrate. The negative electrode active material effectively suppresses SEI generation, has very high capacity, and has excellent battery cycle-life characteristics.

### CROSS-REFERENCE TO RELATED APPLICATION

This application claims priority to and the benefit of Korean Patent Application No. 10-2024-0049629 filed in the Korean Intellectual Property Office on Apr. 12, 2024, the entire contents of which are incorporated herein by reference.

### BACKGROUND

### 1. Field

Negative electrode active materials for rechargeable lithium batteries, negative electrodes and rechargeable lithium batteries are disclosed.

### 2. Description of the Related Art

Rechargeable lithium batteries have high electrochemical capacity and operating potential and excellent charge/discharge cycle characteristics. Thus, rechargeable lithium batteries are widely used in portable information terminals, portable electronic devices, small household power storage devices, motorcycles, electric vehicles, hybrid electric vehicles, etc. With the spread of rechargeable lithium batteries, there is a demand for improved safety and higher performance in the batteries.

An example of a method of increasing the capacity of a rechargeable lithium battery involves using a silicon-containing active material for the negative electrode. When an active material including silicon, which provided for a greater amount of lithium intercalation/deintercalation than conventional carbon-based active materials, is used in the negative electrode, an improvement in capacity can be expected. However, there is a problem in which the negative electrode active material layer expands and contracts violently during charging and discharging. In order to solve these problems, research is underway to change the structure or composition of silicon-based negative electrode active materials. However, there are still limitations such as difficulty in practical application, cycle-life characteristics not being improved, and electrode expansion not being sufficiently suppressed.

### SUMMARY

Example embodiments provide a negative electrode active material for a rechargeable lithium battery with a structure that can effectively suppress excessive production of a film formed on the surface of a silicon-based negative electrode active material during charging and discharging and can improve the cycle-life characteristics of the battery while realizing high capacity.

Some example embodiments provide a negative electrode for a rechargeable lithium battery and a rechargeable lithium battery including the negative electrode active material.

According to example embodiments, a negative electrode active material for a rechargeable lithium battery includes a porous substrate including a zeolite of Chemical Formula 1; and amorphous silicon filled in pores of the porous substrate.

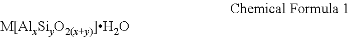

In Chemical Formula 1, 0.1≤x≤3 and 0.1≤y≤3, and M is at least one of Na, K, Mg, Ca, Al, Sr, and Ba.

According to further example embodiments, a negative electrode for a rechargeable lithium battery includes a negative electrode current collector, and a negative electrode active material layer on the negative electrode current collector, wherein the negative electrode active material layer includes the negative electrode active material for a rechargeable lithium battery.

According to still further example embodiments, a rechargeable lithium battery includes the aforementioned negative electrode for the rechargeable lithium battery, a positive electrode, and an electrolyte.

The negative electrode active material for a rechargeable lithium battery effectively suppresses excessive formation of a film formed on the surface of a silicon-based negative electrode active material, while providing a rechargeable lithium battery with very high capacity and excellent battery cycle-life characteristics.

### BRIEF DESCRIPTION OF THE DRAWINGS

FIGS. 1 to 4 are schematic views showing a rechargeable lithium battery according to example embodiments.

FIG. 5 is an X-ray diffraction analysis (XRD) graph for the negative electrode active materials of Example 1 and Comparative Example 1.

### DETAILED DESCRIPTION

Hereinafter, specific embodiments will be described in detail so that those of ordinary skill in the art can easily implement them. However, this disclosure may be embodied in many different forms and is not limited to the example embodiments set forth herein.

The terminology herein is used to describe embodiments only and is not intended to limit the present disclosure. A singular expression includes a plural expression unless the context clearly dictates otherwise.

As used herein, “combination thereof” means a mixture, a laminate, a composite, a copolymer, an alloy, a blend, a reaction product, and the like of the constituents.

Herein terms such as “comprises,” “includes,” or “have” are intended to designate the presence of an embodied feature, number, step, element, or a combination thereof, but the terms do not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, an average particle diameter may be measured by a method well known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating the average particle diameter. The average particle diameter can be measured with a microscope image or a particle size analyzer, and the average particle diameter can refer to the diameter (D₅₀) of a particle with a cumulative volume of 50 volume % in particle distribution.

Herein, “or” is not to be construed as an exclusive meaning, for example, “A or B” is construed to include A, B, A+B, and the like.

An example of a method of increasing the capacity of a rechargeable lithium battery involves using a silicon-based active material for the negative electrode. However, the negative electrode active material layer may violently expand and contract during charging and discharging and as a result, the SEI (Solid Electrolyte Interphase) film, which is an irreversible product, may be continuously damaged. Because damaged SEI film is recovered by consuming lithium and electrolyte solution, as charging and discharging progresses, the SEI film is excessively generated on the surface of the silicon active material. Because of this, problems such as electrical short circuit of the active material and depletion of the electrolyte solution occur and cause a rapid decrease in the cycle-life of the battery.

### Negative Electrode Active Material

In some example embodiments, a negative electrode active material for a rechargeable lithium battery includes a porous substrate including a zeolite of Chemical Formula 1 and amorphous silicon filled in pores of the porous substrate.

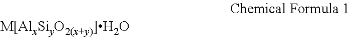

In Chemical Formula 1, 0.1≤x≤3 and 0.1≤y≤3, and M is at least one of Na, K, Mg, Ca, Al, Sr, and Ba. In some example embodiments, 0.2≤x≤2.7, 0.3≤x≤2.4, 0.4≤x≤2.1, 0.5≤x≤1.8, 0.6≤x≤1.5, or 0.7≤x≤1.2, 0.2≤y≤2.7, 0.4≤y≤2.5, 0.6≤y≤2.0, 0.8≤y≤1.7, or 1.0≤y≤1.5.

The negative electrode active material for a rechargeable lithium battery having the above structure can minimize SEI generation during charging and discharging, thereby improving the cycle-life of the battery.

The negative electrode active material according to some example embodiments includes the porous substrate including the zeolite of Chemical Formula 1. A zeolite is a crystalline material in which the central atoms of silicon and aluminum are combined with oxygen atoms in a tetrahedral structure, and the tetrahedral structures are arranged regularly to form a three-dimensional structure. A zeolite has pores of a certain size and shape, and because of this, a zeolite has a specific surface area of hundreds of square meters per unit gram. The basic skeleton of zeolite is made up of silica and alumina, and the aluminum of alumina has a negative charge as it combines with four oxygens. Cations must be present to counteract this negative charge. Zeolites have various pore sizes and shapes depending on their type and have the advantage of being able to control the amount or intensity of acid points over a wide range.

In addition, a porous substrate including a zeolite may absorb water due to a high specific surface area and a structure of the zeolite. Therefore, the porous substrate including a zeolite can absorb water contained as an impurity in and electrolyte solution thereby suppressing generation of strong acid such as HF, which is generated by a reaction of the water with a lithium salt. In addition, the porous substrate including the zeolite has higher density than a general inorganic support to thereby suppress formation of cracks. Thus, a porous substrate including the zeolite has an advantage of suppressing a side reaction due to the crack formation.

Compared to a general inorganic support, the porous substrate including the zeolite may have a Brunner-Emmett-Teller (BET) specific surface area increased by a plurality of pores on the surface, for example, about 1.0 m²/g to about 1,000 m²/g, about 10.0 m²/g to about 1,000 m²/g, or about 100.0 m²/g to about 1,000 m²/g. The specific surface area is measured in accordance with the method of measuring a specific surface area of powder (solid) by gas adsorption of JIS Z8830.

The porous substrate including the zeolite has an average particle diameter (D₅₀) of about 0.5 μm to about 15 μm, for example, about 2 μm to about 14 μm, about 3 μm to about 13 μm, about 4 μm to about 11 μm, or about 5 μm to about 9 μm. In addition, the porous substrate including the zeolite may have an average pore size of about 0.1 nm to about 900 nm, for example, about 0.1 nm to 500 nm, about 0.1 nm to about 300 nm, about 0.1 nm to about 100 nm, or about 0.1 nm to about 50 nm. Furthermore, the porous substrate including the zeolite may have an average pore volume of about 0.001 cm³/g to about 1.0 cm³/g, for example, about 0.001 cm³/g to about 0.9 cm³/g, about 0.001 cm³/g to about 0.8 cm³/g, about 0.001 cm³/g to about 0.7 cm³/g, or about 0.001 cm³/g to about 0.6 cm³/g. If the porous substrate has an average particle diameter, a pore size and a pore volume within each of these ranges, there may be an advantage of achieving a large specific surface area, which facilitates deposition of the amorphous silicon (described below). Herein, the average particle diameter (D₅₀) of the porous substrate means a diameter of particles having a cumulative volume of 50 volume % in the particle size distribution that is obtained by measuring the size of about 20 particles at random in a scanning electron microscope image. For for circular particles, the average particle diameter refers to a diameter of the particle, and for non-circular particles, the average particle diameter means a major axis length.

In the negative electrode active material according to some example embodiments, amorphous silicon is filled in the pores of the porous substrate including the zeolite of Chemical Formula 1.

Some rechargeable lithium batteries use graphite having theoretical capacity of about 372 mAh/g in a negative electrode and have difficulties with respect to high-speed charging and discharging due to excessive formation of an SEI film. In order to overcome these limitations, a silicon-based negative electrode active material having theoretical capacity of about 4,200 mAh/g has been developed. In general, the silicon-based negative electrode is manufactured by mixing a conductive material and a binder with a silicon material into slurry, and then, the slurry is coated on a current collector. Such a slurry type has a problem of low electrical conductivity, but the negative electrode active material according to some example embodiments may solve problems with respect to mechanical damage of electrodes due to volume expansion and contraction according to charges and discharges and the resulting rapid shortening of cycle-life by filling the pores of the porous substrate with the amorphous silicon. In addition, the negative electrode active material according to examples may alleviate excessive growth of an SEI film by preventing particle breakage due to the charge and discharge.

The amorphous silicon may have an average particle diameter (D₅₀) of about 1 nm to about 70 nm, for example, about 1 nm to about 50 nm, about 1 nm to about 30 nm, about 1 nm to about 20 nm, about 1 nm to about 10 nm, or about 1 nm to about 5 nm. If the amorphous silicon has an average particle diameter (D₅₀) within these ranges, there may be advantages of suppressing the volume expansion generated during the charge and discharge and alleviating the excessive growth of the SEI film due to particle breakage during the charge and discharge. As noted above, the average particle diameter (D₅₀) of the amorphous silicon means a diameter of particles having a cumulative volume of 50 volume % in the particle size distribution that is obtained by measuring the size of about 20 particles at random in a scanning electron microscope image.

The amorphous silicon may exist in a partially or fully oxidized form, wherein an atom content ratio of silicon to oxygen in the amorphous silicon, which indicates a decree of the oxidation, may be a weight ratio of about 99:1 to about 33:67. The amorphous silicon may be SiOₓ, wherein x is greater than about 0 and less than about 2.

The zeolite and the amorphous silicon may have a weight ratio of about 50:50 to about 90:10, for example, about 50:50 to about 85:15, about 50:50 to about 80:20, about 50:50 to about 75:25, or about 50:50 to about 70:30. Within these ranges, the excessive growth of an SEI film due to particle breakage may be effectively suppressed during the charge and discharge, thereby improving a cycle-life of a rechargeable lithium battery.

The negative electrode active material for a rechargeable lithium battery may have a full width at half maximum (FWHM) of about 0.1 to about 3.0 at 2θ=28.4° of an X-ray diffraction analysis (XRD). For example, the FWHM may be about 0.2 to about 3.0, about 0.5 to about 3.0, or about 1.0 to about 3.0. The X-ray diffraction analysis is performed at a scan speed of about 0.05°/s to about 0.06°/s by using Cu-Kαrays. If FWHM is within these ranges, the amorphous silicon with a small particle size may be deposited on the porous substrate to prevent the particle breakage due to charging and discharging. This may be different from another negative electrode active material in which silicon is adsorbed into a porous substrate through physical pulverization, such as conventional ball milling and the like, which may have a problem that silicon particles are large and break during the charge and discharge.

The negative electrode active material for a rechargeable lithium battery according to some example embodiments may further include an amorphous carbon coating layer on the surface of the porous substrate. The amorphous carbon coating layer may include amorphous carbon selected from hard carbon, soft carbon, a mesophase pitch carbonized product, calcined coke, and a mixture thereof. The thickness of the amorphous carbon coating layer may be about 1 nm to about 2 μm, for example, about 1 nm to about 500 nm, about 10 nm to about 300 nm, or about 20 nm to about 200 nm. If the thickness of the amorphous carbon coating layer is within these ranges, it may suppress volume expansion during charging and discharging, improve electronic conductivity on the surface, and further contribute to improving the output characteristics of the battery.

### Method of Preparing Negative Electrode Active Material

In some example embodiments, a method of preparing a negative electrode active material includes preparing a porous substrate including a zeolite of Chemical Formula 1 and depositing amorphous silicon on the porous substrate.

The aforementioned negative electrode active material can be prepared through the above-described method. Because the contents of the negative electrode active material are the same as described above, a detailed description is omitted.

The deposition process of the amorphous silicon may be performed by a process of vapor deposition, atomic layer deposition, or thermal evaporation, and the vapor deposition may be chemical vapor deposition or physical vapor deposition. In the deposition process, amorphous silicon can be deposited by supplying a precursor without using a solvent.

Specifically, the step of depositing amorphous silicon may be depositing the amorphous silicon in the pores of the porous substrate using a silicon-based precursor. More specifically, in the step of depositing amorphous silicon, the silicon-based precursor may be silane (SiH₄), dichlorosilane (SiH₂Cl₂), silicon tetrafluoride (SiF₄), silicon tetrachloride (SiCl₄), methylsilane (CH₃SiH₃), disilane (Si₂H₆), or a combination of thereof. In addition, the step of chemical vapor depositing the amorphous silicon may be performed at a temperature range of about 300° C. to about 900° C., for example, about 350° C. to about 800° C., about 400° C. to about 700° C., or about 350° C. to about 500° C. The chemical vapor deposition may take about 10 minutes to about 10 hours, for example, about 20 minutes to about 5 hours, or about 30 minutes to about 1 hour. The silicon-based precursor may be in a liquid or gaseous phase, and specifically, the amorphous silicon may be deposited by vaporizing the liquid or gaseous silicon-based precursor using the aforementioned deposition method.

In contrast, when using a physical adsorption method such as ball milling, silicon particles are simply attached to the porous substrate by physical force during the mixing process of the raw materials. As such, it is almost impossible to uniformly control the distribution of silicon particles. In addition, pulverization is performed simultaneously with mixing of each raw material and destruction of the raw material may occur, which may cause performance deterioration in the final material used in a battery.

### Negative Electrode

The negative electrode for a rechargeable lithium battery includes a negative electrode current collector and a negative electrode active material layer on the negative electrode current collector. The negative electrode active material layer includes the aforementioned negative electrode active material and may further include another type of negative electrode active material, and a binder, and/or a conductive material.

### Binder

The binder serves to adhere the negative electrode active material particles to each other and also to adhere the negative electrode active material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The dry binder may be a polymer material capable of becoming fiber and may be, for example, polytetrafluoroethylene, polyvinylidene fluoride, a polyvinylidene fluoride-hexafluoropropylene copolymer, polyethylene oxide, or a combination thereof.

### Conductive Material

The conductive material is included to provide electrode conductivity and any electrically conductive material may be used as a conductive material provided that it does not cause a chemical change. Examples of the conductive material include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

### Negative Electrode Current Collector

The negative electrode current collector may be selected from copper foil, nickel foil, stainless steel foil, titanium foil, nickel foam, copper foam, a polymer substrate coated with a conductive metal, and a combination thereof.

### Rechargeable Lithium Battery

In some example embodiments, a rechargeable lithium battery includes the aforementioned negative electrode; a positive electrode; and an electrolyte. Herein, the electrolyte may be liquid electrolyte or solid electrolyte.

For example, a rechargeable lithium battery may be provided that includes the aforementioned negative electrode, a positive electrode, a separator between the negative electrode and the positive electrode, and an electrolyte solution. Some example embodiments provide an all-solid-state rechargeable battery including the aforementioned negative electrode, positive electrode, and a solid electrolyte layer between the negative electrode and the positive electrode.

Hereinafter, an example of a rechargeable lithium battery using an electrolyte solution will be described.

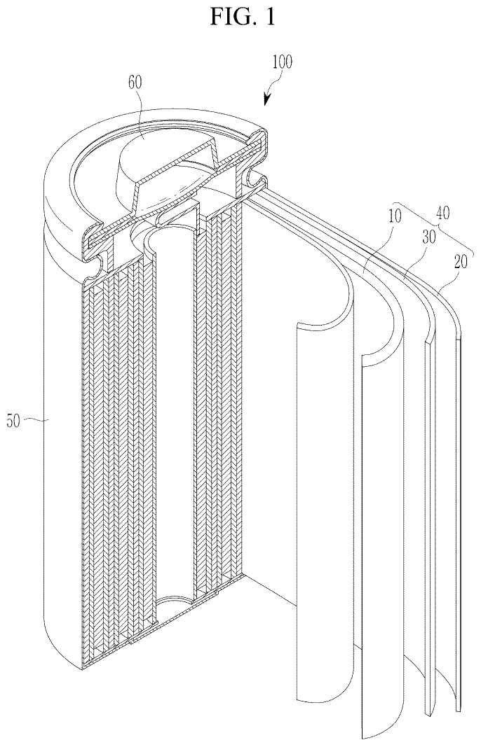

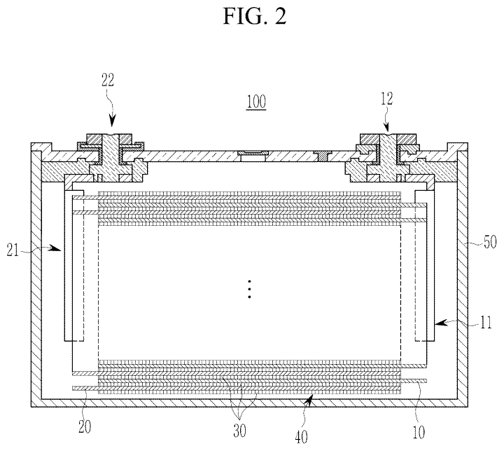

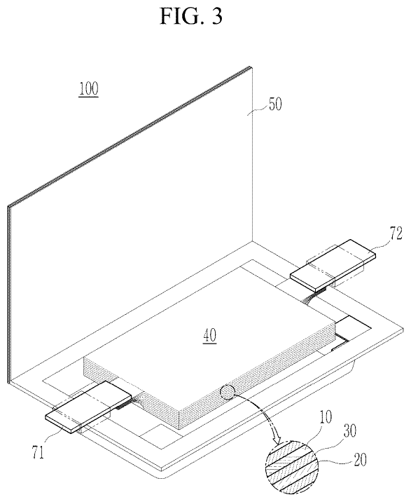

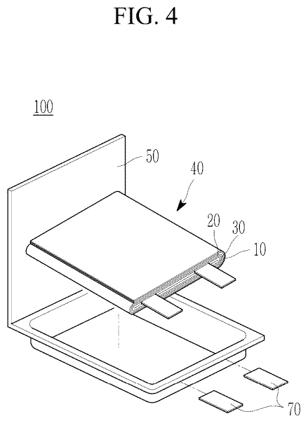

The rechargeable lithium battery may be classified as cylindrical, prismatic, pouch, coin, etc. depending on the shape. FIGS. 1 to 4 are schematic diagrams showing rechargeable lithium batteries according to some example embodiments. FIG. 1 is a cylindrical battery, FIG. 2 is a prismatic battery, and FIGS. 3 and 4 are a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12, a negative lead tab 21, and a negative electrode terminal 22. As shown in FIGS. 3 and 4, the rechargeable lithium battery 100 includes an electrode tab 70, that is, a positive electrode tab 71 and a negative electrode tab 72 serving as an electrical path for inducing the current formed in the electrode assembly 40 to outside of the battery.

### Positive Electrode

The positive electrode is a positive electrode current collector, and a positive electrode active material layer is provided on the positive electrode current collector. The positive electrode active material layer includes a positive electrode active material and may further include a binder and/or a conductive material.

The positive electrode active material may be a compound capable of intercalating and deintercalating lithium (lithiated intercalation compound). For example, one or more types of composite oxides of a metal selected from cobalt, manganese, nickel, and a combination thereof and lithium may be used.

The composite oxide may be a lithium transition metal composite oxide, and examples thereof may include lithium nickel-based oxide, lithium cobalt-based oxide, lithium manganese-based oxide, a lithium iron phosphate-based compound, cobalt-free lithium nickel-manganese-based oxide, or a combination thereof. A compound represented by any of the following chemical formulas may be used as the composite oxide. LiaA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); and LiₐFePO₄ (0.90≤a≤1.8). In these chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be a high nickel-based positive electrode active material having a nickel content of greater than or equal to about 80 mol %, greater than or equal to about 85 mol %, greater than or equal to about 90 mol %, greater than or equal to about 91 mol %, greater than or equal to about 94 mol %, or greater than or equal to 99 mol % based on 100 mol % of a metal excluding lithium in the lithium transition metal composite oxide. The high-nickel-based positive electrode active materials can achieve high capacity and can be applied to high-capacity, high-density rechargeable lithium batteries.

An amount of the positive electrode active material may be about 90 wt % to about 98 wt %, for example, about 90 wt % to about 95 wt %, based on a total weight of the positive electrode active material layer. Each amount of the binder and the conductive material may be about 1 wt % to about 5 wt % based on a total weight of the positive electrode active material layer.

The binder improves binding properties of positive electrode active material particles with one another and with a current collector. Examples of the binder include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like. But the present disclosure is not limited to these examples.

The conductive material is included to provide electrode conductivity and any electrically conductive material may be used as a conductive material provided that it does not cause a chemical change. Examples of the conductive material include a carbon-based material such as natural graphite, artificial graphite, carbon black, acetylene black, ketjen black, a carbon fiber, a carbon nanotube, and the like; a metal-based material of a metal powder or a metal fiber including copper, nickel, aluminum, silver, and the like; a conductive polymer such as a polyphenylene derivative; or a mixture thereof.

Aluminum foil may be used as the positive electrode current collector, but the present disclosure is not limited thereto.

### Electrolyte Solution

The electrolyte solution includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethyl acetate, methyl propionate, ethyl propionate, decanolide, mevalonolactone, valerolactone, caprolactone, and the like. The ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (wherein R is a C2 to C20 linear, branched, or cyclic hydrocarbon group, a double bond, an aromatic ring, or an ether group, and the like; amides such as dimethylformamide; dioxolanes such as 1,3-dioxolane, 1,4-dioxolane, and the like; sulfolanes, and the like.

The non-aqueous organic solvents can be used alone or in a combination of two or more.

When using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl) imide; LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethane sulfonate, lithium difluorobis(oxalato) phosphate (LiDFBOP), and lithium bis(oxalato) borate (LiBOB).

### Separator

Depending on the type of the rechargeable lithium battery, a separator may be provided between the positive electrode and the negative electrode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one polymer selected from polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof. But the present disclosure is not limited to these examples.

The organic material and the inorganic material may be mixed in one coating layer, or a coating layer including an organic material and a coating layer including an inorganic material may be stacked.

Examples and comparative examples of the present disclosure are described below. However, the following are only examples of the present disclosure, and the present disclosure is not limited to the examples.

### EXAMPLE 1

### 1. Manufacturing of Negative Electrode

Amorphous silicon was deposited using a chemical vapor deposition method at a temperature of 450° C. under a SiH₄ gas atmosphere in the presence of a porous substrate including zeolite (Na[AlSi_{1.23}(O₂)_{2.23}]H₂O), preparing a negative electrode active material including the zeolite and the amorphous silicon (a particle diameter: 1 nm to 10 nm) in a weight ratio of 70:30. A flow rate was maintained at 300 sccm, an total reaction time was 60 minutes.

7.3 wt % of the negative electrode active material, 90.0 wt % of graphite, 0.5 wt % of denka black, 0.9 wt % of carboxylmethyl cellulose, and 1.3 wt % of a styrenebutadiene rubber were mixed in water to prepare negative electrode active material slurry. The prepared negative electrode active material slurry was coated on a copper foil and then dried and compressed to manufacture a negative electrode.

### 2. Manufacturing of Positive Electrode

Li₁Ni_{0.916}Co_{0.07}Al_{0.014}O₂ was prepared as a positive electrode active material. 97.7 wt % of the prepared positive electrode active material was mixed with 1.2 wt % of a binder, PVDF, and 1.1 wt % of a conductive material, CNT in an NMP solvent to prepare a positive electrode active material composition. The prepared positive electrode active material composition was coated on an aluminum current collector and then, dried and compressed to manufacture a positive electrode.

### 3. Manufacturing of Battery Cell

The prepared negative electrode, a separator with a polyethylene/polypropylene multi-layer structure, and the prepared positive electrode were stacked to manufacture a pouch type cell, and an electrolyte solution was prepared by adding 1.0 M LiPF₆ lithium salt to a mixed solvent of ethylene carbonate, and diethyl carbonate in a volume ratio of 50:50 was injected into the mixture, thereby manufacturing a rechargeable lithium battery cell.

### COMPARATIVE EXAMPLE 1

A rechargeable lithium battery cell was manufactured in the same manner as in Example 1 except that crystalline nano silicon particles obtained by pulverizing silicon with a wet milling equipment (Laboratory Agitator Bead Mill-Labstar, NETZSCH Premier Technologies, LLC.) for 10 hours were used as a negative electrode active material.

### COMPARATIVE EXAMPLE 2

A rechargeable lithium battery cell was manufactured in the same manner as in Example 1 except that amorphous silicon with an average particle diameter of 100 nm was deposited on the zeolite.

### COMPARATIVE EXAMPLE 3

A rechargeable lithium battery cell was manufactured in the same manner as in Example 1 except that a carbon-silicon mixture was prepared by mixing the nano silicon particles prepared in Comparative Example 1 with a carbon precursor and heat-treating the mixture, which was then used as a negative electrode active material.

### EVALUATION EXAMPLE 1; AND PORE VOLUME ANALYSIS

The pore volumes of the prepared negative electrode active materials were measured using a BJH (Barrett-Joyner-Halenda) analysis equipment, and the results are shown in Table 1. The BJH measurement was performed with a method of measuring adsorption/desorption amounts according to a pressure change onto each sample, while changing a pressure from 0 mHg to 950 mmHg by using nitrogen gas at a liquid nitrogen temperature of −198° C. by using a BJH (Manufacturer: Micromeritics Instrument Corp., Model name: ASAP 2460) analysis equipment.

TABLE 1

| | Pore volume (cm³/g) |
|---|---|
| Example 1 | 0.005 |
| Comparative Example 1 | 1.00 |
| Comparative Example 2 | 1.00 |
| Comparative Example 3 | 0.01 |

Referring to Table 1, as compared to the comparative examples, the negative electrode active material of Example 1 was confirmed to have a small pore volume and exhibit good deposition of amorphous silicon.

### EVALUATION EXAMPLE 2: CRYSTALLINITY ANALYSIS OF SILICON

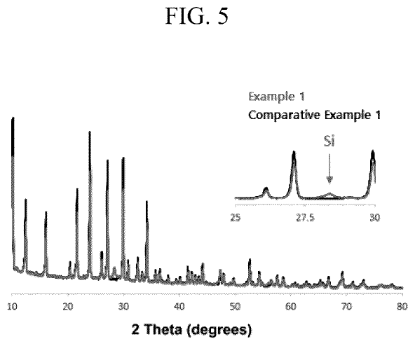

X-ray diffraction analysis (XRD) was performed on the negative electrode active materials of Example 1 and Comparative Example 1, and the results are shown in FIG. 5. The X-ray diffraction analysis was performed by using Cu-Kαrays within a range of 2θ=10° to 80° under conditions of a scan speed (°/s) of 0.054, a step size (°/step) of 0.01313, and time per step of 62.475 s. As the XRD analysis result, Example 1 exhibited an Si 111 peak at 2θ=28.4°. On the other hand, Comparative Example 1 exhibited no Si characteristic peak.

### EVALUATION EXAMPLE 3: VOLUME EXPANSION ANALYSIS

Each of the rechargeable lithium battery cells according to Example 1 and Comparative Examples 1 to 3 was constant current-charged to 4.25 V at a rate of 1.0 C and cut off at a rate of 0.05 C in a constant voltage mode of 4.25 V at 45° C. Subsequently, the cells were discharged to a voltage of 2.8 V at a rate of 1.0 C. The expansion degrees of the battery cells according to charges and discharges, and the results are shown in Table 2. A thickness at the 50th charge and discharge cycle was compared to that at the first cycle after the formation.

TABLE 2

| | Expansion rate |
|---|---|
| Example 1 | 15% |
| Comparative Example 1 | 30% |
| Comparative Example 2 | 25% |
| Comparative Example 3 | 20% |

As compared to Comparative Examples 1 to 3, Example 1 exhibited a low expansion rate.

### EVALUATION EXAMPLE 4: ANALYSIS OF CYCLE-LIFE CHARACTERISTICS OF BATTERY CELLS

Each of the rechargeable lithium battery cells of Example 1 and Comparative Examples 1 to 3 was constant current-charged to a voltage of 4.25 V at a rate of 1.0 C and cut off at a rate of 0.05 C in a constant voltage mode of maintaining 4.25 V at 45° C. Subsequently, the cells were discharged to a voltage of 2.8 V at a rate of 1.0 C, whose cycle was 100 times repeated. Each charge and discharge cycle was followed by a 10-minute pause. The capacity changes according to the cycles are shown in Table 3. In the table, the symbol “O” indicates that the capacity retention was 80% or more, the symbol “A” indicates that the capacity retention was greater than 70% and less than 80%, the symbol “X” indicates that the capacity retention was less than 70%.

TABLE 3

| | Capacity retention rate |
|---|---|
| Example 1 | ◯ |
| Comparative Example 1 | X |
| Comparative Example 2 | X |
| Comparative Example 3 | Δ |

As compared to Comparative Examples 1 to 3, Example 1 was confirmed to exhibit excellent capacity retention characteristics.

While this disclosure has been described in connection with what is presently considered to be practical example embodiments, it is to be understood that the disclosure is not limited to the disclosed embodiments. Rather, it covers various modifications and equivalent arrangements included within the spirit and scope of the present disclosure.

### DESCRIPTION OF SYMBOLS

100: rechargeable lithium battery 10: positive electrode
11: positive electrode lead tab 12: positive terminal
20: negative electrode 21: negative electrode lead tab
22: negative terminal 30: separator
40: electrode assembly 50: case
60: sealing member 70: electrode tab
71: positive electrode tab 72: negative electrode tab

What is claimed is:

1. A negative electrode active material for a rechargeable lithium battery comprising
a porous substrate including a zeolite of Chemical Formula 1; and
amorphous silicon filled in pores of the porous substrate,
wherein Chemical Formula 1 is: 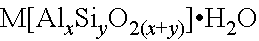
with 0.1≤x≤3 and 0.1≤y≤3, and with M being at least one of Na, K, Mg, Ca, Al, Sr, and Ba.

2. The negative electrode active material as claimed in claim 1, wherein the porous substrate has an average particle diameter (D₅₀) of about 0.5 μm to about 15 μm.

3. The negative electrode active material as claimed in claim 1, wherein an average pore size of the pores of the porous substrate is about 0.1 nm to about 900 nm.

4. The negative electrode active material as claimed in claim 1, wherein an average volume of the pores of the porous substrate is about 0.001 cm³/g to about 1.0 cm³/g.

5. The negative electrode active material as claimed in claim 1, wherein the amorphous silicon has an average particle diameter (D₅₀) of about 1 nm to about 70 nm.

6. The negative electrode active material as claimed in claim 1, wherein a weight ratio of the zeolite to amorphous silicon is about 50:50 to about 90:10.

7. The negative electrode active material as claimed in claim 1, wherein the negative electrode active material has a full width at half maximum (FWHM) of about 0.1 to about 3.0 at the 2θ=28.4° position in X-ray diffraction analysis.

8. The negative electrode active material as claimed in claim 1, further comprising an amorphous carbon coating layer on the surface of the porous substrate.

9. A method of preparing a negative electrode active material for a rechargeable lithium battery, the method comprising:
preparing a porous substrate including a zeolite of Chemical Formula 1; and
depositing amorphous silicon on the porous substrate,
wherein Chemical Formula 1 is: 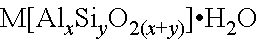
with 0.1≤x≤3 and 0.1≤y≤3, and with M being at least one of Na, K, Mg, Ca, Al, Sr, and Ba.

10. The method as claimed in claim 9, wherein the deposition is performed by vapor deposition, atomic layer deposition, or a thermal evaporation process.

11. The method as claimed in claim 9, wherein the deposition is performed by a chemical vapor deposition process.

12. The method as claimed in claim 11, wherein the chemical vapor deposition is performed for about 10 minutes to about 10 hours at a temperature of about 300° C. to about 900° C.

13. A negative electrode for a rechargeable lithium battery, comprising:
a negative electrode current collector, with a negative electrode active material layer provided on the negative electrode current collector,
wherein the negative electrode active material layer includes the negative electrode for the rechargeable lithium battery active material as claimed in claim 1.

14. A rechargeable lithium battery comprising: a negative electrode including the negative electrode active material for a rechargeable lithium battery as claimed in claim 1;
a positive electrode; and
an electrolyte.
